(19) United States
(12) Patent Application Publication
(10) Pub. No.: US 2009/0293019 A1
(43) Pub. Date: Nov. 26, 2009

(54) USER INTERFACE HAVING SLIDER CONTROLS FOR WEIGHTED PARAMETERS IN SEARCHING OR DECISION MAKING PROCESSES

(76) Inventors: Keith Raffel, Palo Alto, CA (US); Caryn Reddick, San Jose, CA (US); Timothy Roy Huntington, Monterey, CA (US)

Correspondence Address: WILSON, SONSINI, GOODRICH & ROSATI, 650 PAGE MILL ROAD, PALO ALTO, CA, 94304-1050, US

(21) Appl. No.: 12/469,629

(22) Filed: May 20, 2009

Related U.S. Application Data
(60) Provisional application No. 61/055,424, filed on May 22, 2008.

(51) Int. Cl. G06F 3/048

(52) U.S. Cl. 715/833

(57) ABSTRACT

User interface having slider controls for weighted parameters in searching or decision making processes. Slider controls may correspond to certain search parameters, which may be given more or less weight in searching depending on the user's adjustments to the position of the slider controls. A sliding display element may also include a display icon that changes with respect to the position of a slider control, in real-time. Search results may also be updated in real-time based on user input.

### CROSS-REFERENCE

This application claims the benefit of U.S. Provisional Application No. 61/055,424, filed May 22, 2008, which application is incorporated herein by reference.

### FIELD OF INVENTION

The invention relates to user interfaces for searching and decision making processes. More particularly, the invention relates to a user interface having slider controls for weighted parameters in searching or decision making processes.

### BACKGROUND

Free or relatively inexpensive computer software applications such as Internet “search engines” allow users to conduct searches over the Internet or other networks. Individual users can obtain information on a topic of interest. For example, a user may type in a subject or key word and generate a list of network sites (i.e. web sites). Thus, with home pages published by thousands of companies, universities, government agencies, museums, municipalities, other users and individuals, and other various entities, the Internet can be a valuable resource. The market for Internet access and related applications is explosive and is continuously growing.

A problem associated with these types of Internet search engines is simply dealing with the vast amount of potential data that may be searched and retrieved. By entering certain keywords into such search engines, unwanted data, in addition to the desired data, may be discovered by the search engine, forcing the user to wade through often useless and unwanted search results in order to get to the desired data. Further, many interfaces limit search parameters to keywords to be entered into text fields. In addition, interfaces operate by the user first entering in a keyword, and then a list of results are displayed, instead of operating in real time.

From the foregoing it can be appreciated that a need exists for tailoring interfaces for searching and decision making processes to the needs of a particular user. Better interfaces are needed for users to operate searches and decision making processes in real time, and to better utilize interfaces to filter unwanted data.

### SUMMARY OF INVENTION

The invention provides a user interface having slider controls for weighted parameters used in searching or decision making processes. Various aspects of the invention described herein may be applied to any of the particular applications set forth below. The invention may be applied as a standalone interface or as a component of an integrated software solution for searching and decision making processes. The invention can be optionally integrated into existing business, search, and decision making processes seamlessly. It shall be understood that different aspects of the invention can be appreciated individually, collectively or in combination with each other.

One aspect of the invention provides a system for searching with weighted parameters comprising a sliding display element including a bar and a slider. The bar represents a scale of values, and the slider may be adjustable to a position with respect to the bar, and can be associated with a value. The sliding display element may correspond to a parameter for searching. Thus, when the user adjusts the slider to a certain position, then the value of the position of the adjusted slider may correspond to a weight for the particular parameter, to be used in a search or decision making process. Further, each sliding display element may include a display icon that changes with respect to the position of the slider, in real-time.

Another aspect of the invention may provide for a method for searching with weighted parameters. The method may include a step for loading a search interface in a browser. Another step may be to receive user input for adjusting at least one search parameter including input from a slider control corresponding to the search parameter. The search results may also be updated in real-time based on the user input. In addition, the method may also have a step for updating an icon which corresponds to the slider control, in real-time.

Unless specifically stated otherwise, as apparent from the following discussions, it is appreciated that throughout the specification, discussions utilizing terms such as “processing,” “computing,” “calculating,” “determining,” or the like, may refer in whole or in part to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices. It will also be appreciated by persons skilled in the art that the term “users” referred to herein can be individuals as well as corporations and other legal entities. Furthermore, the processes presented herein are not inherently related to any particular computer, processing device, article or other apparatus. An example of a structure for a variety of these systems will appear from the description below. In addition, embodiments of the present invention are not described with reference to any particular processor, programming language, machine code, etc. It will be appreciated that a variety of programming languages, machine codes, etc. may be used to implement the teachings of the invention as described herein.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

Some of the features of the invention are described as set forth in the following figures and description. A better understanding of the features and advantages of the invention will be obtained by reference to the following detailed description that sets forth illustrative embodiments provided in accordance with the invention.

FIG. 1 illustrates an interface for searching or decision making processes using slider controls.

FIG. 2 illustrates an example of a slider control that can be used in various embodiments of the invention.

FIG. 3 shows an example of a search interface for universities and colleges using slider controls and weighted parameters.

FIG. 4 is an exemplary network diagram illustrating some of the platforms which may be employed with various embodiments of the invention.

FIG. 5 depicts a flowchart of a method for searching using slider controls and weighted parameters, in accordance with an embodiment of the present invention.

### DETAILED DESCRIPTION OF INVENTION

In the following detailed description, numerous specific details are set forth in order to provide a thorough understanding of the invention. However it will be understood by those of ordinary skill in the art that the invention may be practiced without these specific details. In other instances, well-known methods, procedures, components and circuits have not been described in detail so as not to obscure the invention. Various modifications to the described embodiments will be apparent to those with skill in the art, and the general principles defined herein may be applied to other embodiments. The invention is not intended to be limited to the particular embodiments shown and described.

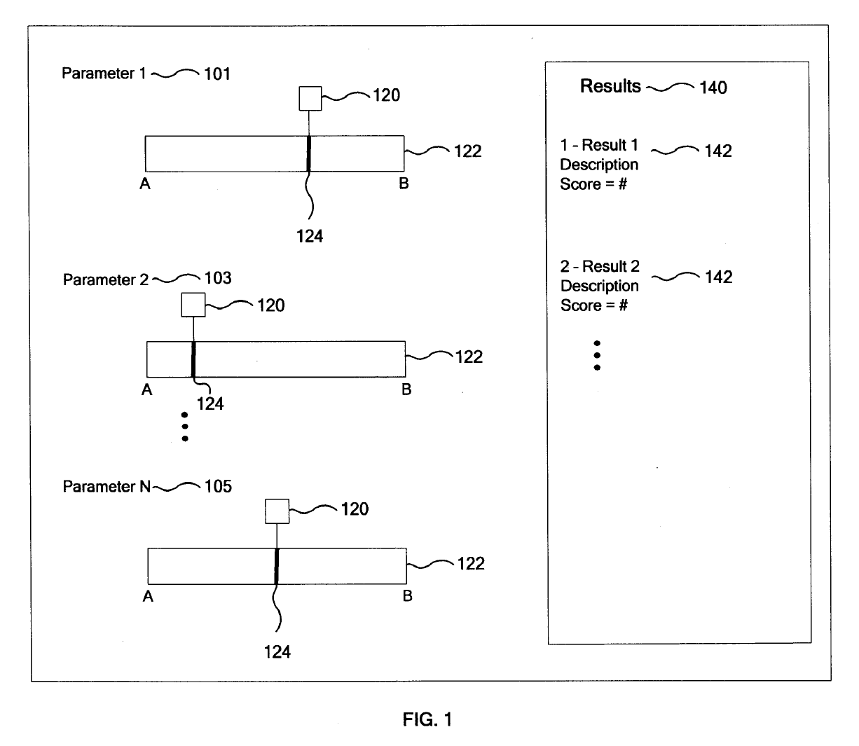

Referring to FIG. 1, various user-interface elements may facilitate a search or other decision making process. These user-interface elements may search across a variety of fields or parameters, and may search any body of information. For example, as shown, various parameters 101, 102, . . . , 105 may be searched. In any given search, there may be one or more parameters or fields that are being searched. Further, other user-interface elements may be used to facilitate the search such as check boxes, icons, numeric or text entry fields, pop-up lists or menus, pull-down lists or menus, push buttons, radio buttons, sliding display elements, scrolling lists, spin boxes, and so forth. The user-interface element 122, as shown, is a sliding display, but the invention will not be limited to what is shown or described here, and various user-interface elements are contemplated by the invention.

As shown in FIG. 1, each user-interface element can be associated with a different search parameter. For example, in a search for colleges and universities, search parameters may include location, size of school, school ranking, student population, etc. As another example, a search for real estate may include property value, location, number of bedrooms or bathrooms, square footage, etc. Such parameters 101, 102, . . . , 105 can be used to conduct searches or other decision making processes.

To facilitate a search, at least one user-interface element of one parameter may represent a scale of values of a parameter. For instances, the first user-interface element can include a sliding display element that represents a scale of values of a parameter. The scale of values refers to an arrangement of values, such that various intervals in the arrangement of values can be associated with varying differences in values. In some instances, a nonlinear scale of values can be envisioned as an axis of values in which a set of marks are placed at regularly spaced intervals along the axis and in which various intervals along the axis can be associated with varying differences in values. An example of a nonlinear scale of values is a logarithmic scale of values.

In one embodiment of the invention, several parameters 101, 103, 105 may be used in a search function. For example, the user may use user-interface elements to set desired values for more than one parameter 101, 103, 105. As shown in FIG. 1, the user-interface elements may be one or more slider controls 122 that correspond to various parameters 101, 103, 105. The slider control 122 may have a slider 124 that can be adjusted by the user. When the user moves slider 124, the user may indicate a desired value for the parameter 101.

In one embodiment of the invention, an icon 120 may be updated according to the user's selection of the location for slider 124. As the slider 124 moves from point A to point B or from point B to point A, the icon 120 may update based upon the user's selection. The icon 120 may be updated in real-time, as the slider 124 is moving. The icon 120 may reflect the user's choices, being closer to point A or closer to point B.

Based on each of the parameters 101, 103, and 105, and the user's selections of values for the various user-interface elements, the system may conduct a search on a database to display various search results 140. The search results 140 may be based on the user's selections for the various user-interface elements. For example, in a search of universities or colleges, if one parameter is the size of the university, and the user moves the sliding control to indicate that the user wants to see universities of a large size, then the search results 140 may be ranked such that the top results show large universities. These results may be limited based on various parameters, or may be weighted based on the various parameters. Certain parameters may also be given more weight than others.

Certain parameters 101, 103, and 105 may be given more weight than others based on pre-determined weight values. For example, in a search for a university, the system may weigh location of a university or cost of attendance more than school culture or lifestyle. Further, the search results may also reflect the values chosen by the user-interface elements. In one embodiment, if the user sets the slider 124 of a slider control 122 extremely close to point A or extremely close to point B, that parameter may be given more weight than another parameter in which the user set the slider control closer to the middle in between point A and B. The system may be able to accommodate situations in which users want certain parameters weighed more heavily than other parameters.

Further, as the user adjusts each of the slider controls 122 or other user-interface elements, the search results 140 may be updated in real-time, to reflect the user's choices for each of the parameters 101, 103, and 105. For instance, the system may search a database to identify the search results 140. As the user adjusts each of their choices for each of the parameters 101, 103, and 105, the search results 140 may update based on the user's updated choices in real-time.

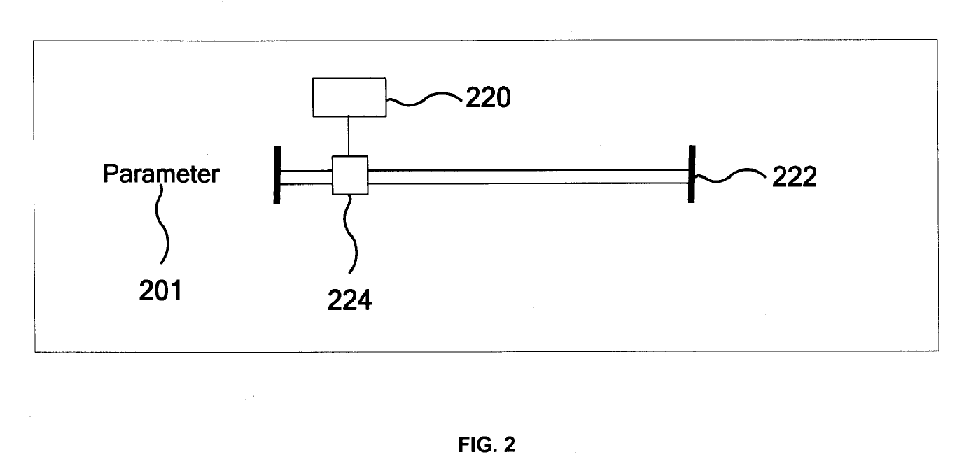

FIG. 2 shows one example of a user-interface element as a sliding display element or slider control corresponding to a parameter 201. In this example, the slider control includes a bar 222 and a slider 224. A user may move the slider 224 along the bar 222, and the slider may correspond to a series of values along the bar 222. Each slider 224 may be moved independently to fine tune a search. The slider 224 may be moved by, for example, a click and drag operation to specify a certain value to target in a search. When the user moves the slider 224 along the bar 222, the user may indicate a desired value for the parameter 201.

In one embodiment of the invention, an icon 220 may be updated according to the user's selection of the location for slider 224. As the slider 224 moves from one end of the bar 222 to the other, the icon 220 may update based upon the user's selection. The icon 220 may be updated in real-time, as the slider 224 is moving. The icon 220 may reflect the user's choices, being closer to one end of the bar 222 or the other end. One skilled in the art can appreciate that while one slider 224 is shown in FIG. 2, it should be recognized that more sliders can be included in some embodiments of the invention. For instance, the sliding display element can include two sliders that would set endpoints for specific values or a particular range of values included in the scale of values for the parameter. In addition, while a single bar 222 is shown in FIG. 2, it is contemplated that the sliding display element may include several bars along with one or more sliders.

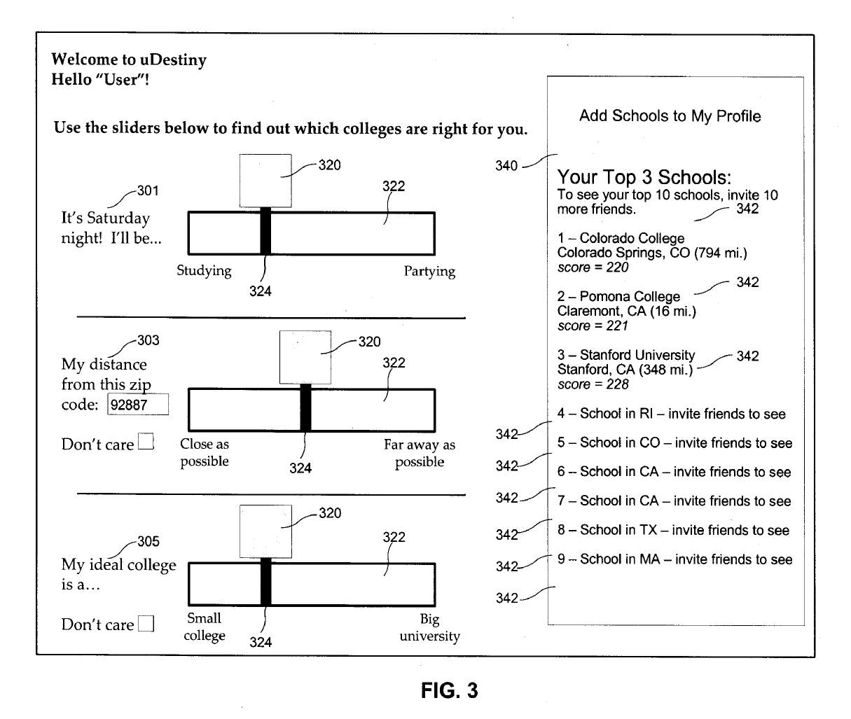

Referring to FIG. 3, in one example, the search is one for universities and colleges, and the search parameter 301 asks, “It's a Saturday night! I'll be . . . . ” On one end of the slider control 322, the choice may be “Studying” and on the other end the choice may be “Partying.” The user may move slider 324 along the spectrum, to be closer to “Studying” or “Partying” to indicate their preference or selection. As the user moves the slider 324 along the slider control 322, the icon 320 may update. As the slider 324 gets closer to “Studying,” the icon 320 may have more and more books piled on. As the slider 324 gets closer to “Parting,” the icon 320 may change to a different icon without any books entirely. The icon may change on several points of the spectrum, and one slider control element may be associated with a variety of icons, which may change depending on where the slider 324 is along the spectrum. One can appreciate that the invention is not limited to any particular icons or parameters for searching.

One application of the invention is a search for universities and colleges, as discussed above. FIG. 3 shows an example of a user interface that involves a search for universities and colleges using various sliders 322 for user-interface elements. The user interface may include several parameters 301, 303, and 305, in which the user may set preferences for whether for example, in 301, they would like to go to a more academic institution or more of a “party-school”; in 303, the distance they would like to be from a certain zip code (or hometown); in 305, they would like to attend a small college or a large university; they are concerned with the school's ranking; whether sports teams are important to them; they would prefer their classmates views to be more liberal or conservative; they prefer warmer or colder weather; they would like to be in a rural area or in a very large city; their high school ranking is high or low; their SAT score is high or low, etc. It can be appreciated that where each user lies on the spectrum of each of these parameters may be set using a slider control 322, for example. The invention, however, is not limited to this user-interface element, and a variety of other elements may be used, as discussed above. Further, the interface is not required to have each of these parameters, but rather, the invention contemplates having one or many parameters, with a variety of user-interface elements. In addition, the interface can have as few as one search parameter or an unlimited number of search parameters, as is appropriate for each instance.

As preferences or choices are set for each of the parameters 301, 303, and 305, a number of search results 340 may be updated to reflect the user's selections and choices. For example, in a university or college search, the results 340 may reflect which schools or universities correspond most to the choices of the user in the selections on the slider controls 322. Each of the results 342 may be ranked based on a score with how well they match to the user's selections for the parameters 301, 303, and 305.

In addition, certain parameters 301, 303, and 305 may be given more weight than others based on pre-determined weight values. For example, the system may weigh location of a university or cost of attendance more than school culture or lifestyle. Further, the search results may also reflect the values chosen by the user-interface elements. In one embodiment, if the user sets the slider 324 of a slider control 322 for the parameter for location of school 303 extremely close to “Close as possible” that parameter may be given more weight than another parameter in which the user set the slider control closer to the middle. As a result, the search results 340 would reflect the weight of the location parameter being given more weight than another parameter in which the user set the slider control 324 closer to the middle of the spectrum. The system may be able to accommodate situations in which users want certain parameters weighed more heavily than other parameters.

In the case of slider controls, a user may move a slider 324 may specify a position with respect to the bar, which position is a target value that is preferred by the user. For example, in a search for a college or university, a user may adjust the position of a slider to correspond to a certain SAT score that the user wants the system to consider in a search for certain colleges or universities. The slider 324 may also be adjusted to specify the weight to be given to a certain parameter in a search. For example, in a search for a college or university, the user may adjust the position of a slider to indicate how important it is that the school has strong sports programs. In other embodiments of the invention, there may be two sliders which may specify upper and lower limits for a range of target values. For example, in a search for a college or university, there user may be able to adjust two sliders to set an upper and lower limit for tuition costs and fees.

In certain embodiments of the invention, the characteristics of each search result 342 may be updated based on user input as well. For example, in a search for universities or colleges, if a certain school is known as a “party-school” then users may be able to input this information and update the system's database accordingly, and the popular perception or opinion may also be reflected in subsequent search results. Users may be able to rate certain characteristics of colleges or universities. Thus other users may be able to benefit from popular knowledge or public perception of certain colleges or universities, and the database may be updated to reflect such knowledge or opinion.

As will be appreciated, the various functionalities described herein may be implemented in a wide variety of ways without departing from the scope of the invention. For example, a specific embodiment of the invention may be for facilitating searching from a web page where the invention is embedded in the page html (e.g., in Javascript). However, depending on the computing context and the particular application, a wide variety of other commercially available or proprietary tools may be employed. For example, the interface may be implemented as a stand-alone widget, as a desktop application or plug-in, or integrated with a desktop application (e.g., in a toolbar). In addition, the computer program instructions with which embodiments of the invention are implemented may be stored in any type of computer-readable media, and may be executed according refers to a variety of computing models including a client/server model, on a stand-alone computing device, or according to a distributed computer model in which various of the functionalities described herein may be effected or employed at different locations.

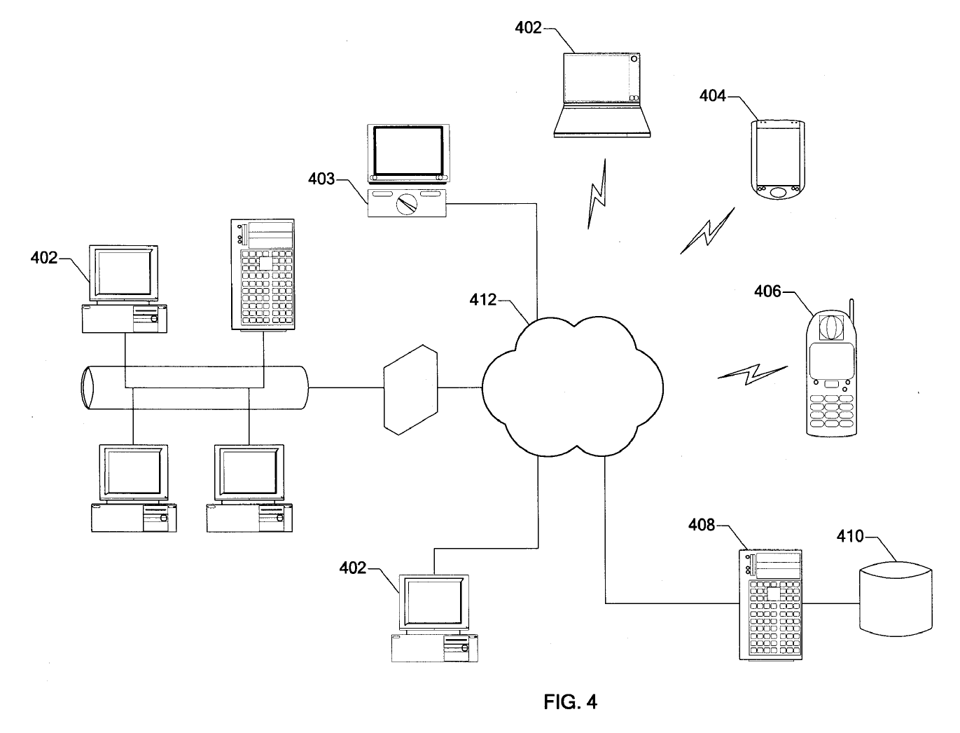

It should also be noted that the present invention may be implemented on any computing platform and in any network topology in which search is a useful functionality. For example and as illustrated in FIG. 4, implementations are contemplated in which the interfaces described herein are employed on personal computers 402, media computing platforms 403 (e.g., cable and satellite set top boxes with navigation and recording capabilities (e.g., digital video recorders)), handheld computing devices (e.g., PDAs) 404, cell phones 406, or any other type of portable communication platform. As discussed above, such interfaces may be resident on such devices, e.g., as part of a browser or other application, or be served up from a remote site, e.g., in a web page, (represented by a server 408 and data store 410). The invention may also be practiced in a wide variety of network environments (represented by network 412), e.g., TCP/IP based networks, telecommunications networks, wireless networks, etc.

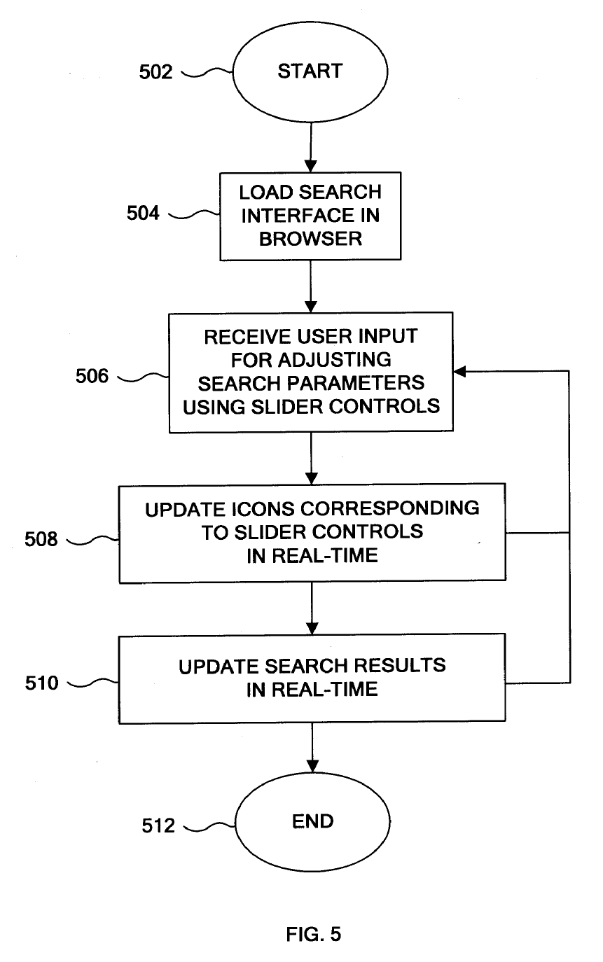

Another aspect of the invention provides for methods for accomplishing the foregoing. FIG. 5 shows one example of a flowchart for a method for searching using slider controls and weighted parameters, in accordance with an embodiment of the present invention. In step 504, a search interface is loaded into a browser. As discussed above, the search interface may have one or more areas in which a user may input selections or preferences, keyword text searches, adjust slider controls, etc. via various user-interface elements such as check boxes, icons, numeric or text entry fields, pop-up lists or menus, pull-down lists or menus, push buttons, radio buttons, sliding display elements, scrolling lists, spin boxes, etc. In step 506, the user input is received. In one embodiment, the user input includes the user's selections on slider controls that have been adjusted for certain parameters for searching. In step 508, as the user may adjust the slider controls, certain icons or other images or display elements corresponding to the controls may be updated in real-time. These icons may correspond to the user's choices, as the user moves a slider from one endpoint to another. In step 510, the search results may be displayed, and appropriately updated in real-time. The user can further adjust the slider controls or other user-interface elements via step 506, and the icons and search results may continue to be updated in real-time via step 508 and 510.

The user interface allows for searching and decision making in a unique way, by adjusting various parameters, and providing the user with instant feedback for how those parameters affect their search results. Because the icons and search results may be updated in real-time, as the user is adjusting slider controls or other user-interface elements, the user is able to determine how and to what degree their inputs affect the search results. In addition, certain search parameters can be given more weight than others, and also can be adjusted in real-time accordingly. It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A graphical user interface for providing search results based on weighted parameters comprising:
a sliding scale display including at least one bar and corresponding slider, wherein the bar represents a scale for a selected search parameter and the slider being adjustable to a position with respect to the bar representing a value for the selected search parameter;
wherein the selected search parameter is assigned a predetermined weight value.

2. The graphical user interface of claim 1, further comprising:
a display icon for the sliding scale display;
wherein the display icon changes with respect to the position of the adjusted slider.

3. The graphical user interface of claim 1, wherein the weighted parameters represent characteristics of schools and the search results are schools matching the values selected for the search parameters.

4. The graphical user interface of claim 1, wherein the search results are updated in real-time as the slider is adjusted by a user.

5. A method for searching with weighted parameters comprising the steps of:
loading a search interface in a browser;
receiving user input for adjusting at least one search parameter including input from at least one slider control corresponding to said search parameter;
computing a set of search results based on the user input; and
updating the set of search results based on the user input.

6. The method of claim 5, further comprising the step of updating an icon corresponding to the slider control.

7. The method of claim 5, wherein the at least one search parameter represents a characteristic of schools, and the set of search results is a list of matching schools.

8. The method of claim 5, wherein the at least one search parameter represents a characteristic of real estate property, and the set of search results is a list of matching properties.

9. The method of claim 5, wherein at least one search parameter is assigned a pre-determined weight value.

10. A graphical user interface for displaying search results comprising:
a plurality of sliders corresponding to a set of weighted parameters, wherein each parameter is represented by a graphical slider display element that is slidably positioned to indicate a user selected value for each weighted parameter.

11. The graphical user interface of claim 10, wherein the plurality of sliders is displayed as a stand-alone widget.

12. The graphical user interface of claim 10, wherein the plurality of sliders is displayed as a desktop application.

13. The graphical user interface of claim 10, wherein the plurality of sliders is embedded on a webpage.
